(19) United States
(12) Patent Application Publication
(10) Pub. No.: US 2012/0013115 A1
(43) Pub. Date: Jan. 19, 2012

(54) Educational Tool

(75) Inventors: Gregory David Burke, Forestville (AU); Jo-Jo Wai Yan Burke, Forestville (AU)

(73) Assignee: G & JB Enterprises Pty Limited, Forestville (AU)

(21) Appl. No.: 12/836,522

(22) Filed: Jul. 14, 2010

(51) Int. Cl. B42F 21/00

(52) U.S. Cl. 283/38

(57) ABSTRACT

An educational tool is described including a number of pages, at least some of which bear elements of page information; a number of tabs are associated with the pages, at least some of which bear elements of tab information; wherein the elements of tab information on each tab define criteria for identifying at least one corresponding element of page information borne on the page with which each tab is associated.

### FIELD OF THE INVENTION

The present invention relates to educational tools and in particular to educational tools used in teaching literacy or numeracy.

The invention has been developed primarily for use as an educational tool used in teaching literacy or numeracy, and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

### OBJECT OF THE INVENTION

It is an object of the present invention to overcome or ameliorate at least one of the disadvantages of the prior art, or to provide a useful alternative.

It is an object of the invention in its preferred form to provide an educational tool used in teaching literacy or numeracy.

### SUMMARY OF THE INVENTION

According to an aspect of the invention there is provided an educational tool including:
a number of pages, at least some of which bear elements of page information;
a number of tabs are associated with the pages, at least some of which bear elements of tab information;
wherein the elements of tab information on each tab define criteria for identifying at least one corresponding element of page information borne on the page with which each tab is associated.

Preferably, the elements of page information may include any of words, images, shapes or colours. More preferably, elements of tab information may include any of letters, numbers, images, shapes or colours.

Preferably, at least one of the tabs may bear at least two elements of tab information. More preferably, the elements of tab information may combine to define criteria for identifying the corresponding elements of page information.

Preferably, at least one of the tabs may have first and second faces and may bear tab information on both faces. More preferably, one of the faces bears alpha-numeric tab information and the other face bears tab information in another form, having a meaning corresponding to the tab information borne on the first face.

Preferably, tab information may include a shape, being the shape of the outline of the tab. Preferably, tab information may include a shape, being the shape of a cut out portion of the tab.

Preferably, a tab may be associated with every one of the pages. Preferably, the tabs may be formed from silicon or loops or ribbon.

Preferably, the pages may be formed from thick material. More preferably, the pages may have wipe clean surfaces.

According to a further aspect of the invention there is provided a user access interface for a processor device, the processor device being adapted to present an educational tool, the processor device being coupleable to database having page data indicative of one or more pages and tab data indicative of one or more respective tabs; the interface comprising a control program adapted to present a page with an associated tab; the control program being further adapted to receive user input indicative of identifying at least one corresponding element of page information borne on the page with which each tab is associated.

According to a further aspect of the invention there is provided a method of educating, the method comprising the steps of:
(a) providing a user access interface coupleable to database having page data indicative of one or more pages and tab data indicative of one or more respective tabs;
(b) retrieving page data and presenting at least one page;
(c) retrieving tab data and presenting one or more tabs associated with each page; and
(d) receiving user input indicative of identifying at least one corresponding element of page information borne on the page with which each tab is associated.

According to a further aspect of the invention there is provided a computer program product stored on a computer usable medium, the computer program product adapted to provide a method as herein described.

According to a further aspect of the invention there is provided a computer readable medium for operation with a processor device, the computer readable medium comprising computer code for executing a method as herein described.

### BRIEF DESCRIPTION OF THE DRAWINGS

A preferred embodiment of the invention will now be described, by way of example only, with reference to the accompanying drawings in which:

FIG. 1 is a perspective view of an embodiment of an educational tool in the form of a book intended for use by children;

FIG. 2 is a perspective view of an alternative embodiment of an educational tool;

FIG. 3A shows a portion of a page with a projection of the book of FIG. 1;

FIG. 3B shows the page portion of FIG. 3a from the rear;

FIG. 3C shows two pages of the book of FIG. 1 together;

FIG. 3D shows the pages of FIG. 3c from the rear;

FIG. 3E to FIG. 3H are views of portions of pages and tabs of the book of FIG. 2, which correspond to the views in FIG. 3A to FIG. 3D;

FIG. 4 shows the entire page of FIG. 3A;

FIG. 5A to FIG. 21H show partial views of pages with associated projections in views corresponding to the views of FIGS. 3A to 3H;

FIG. 22 shows further variations of projections that can be used; and

FIG. 23 shows an embodiment processor device for presenting an educational tool.

### PREFERRED EMBODIMENT OF THE INVENTION

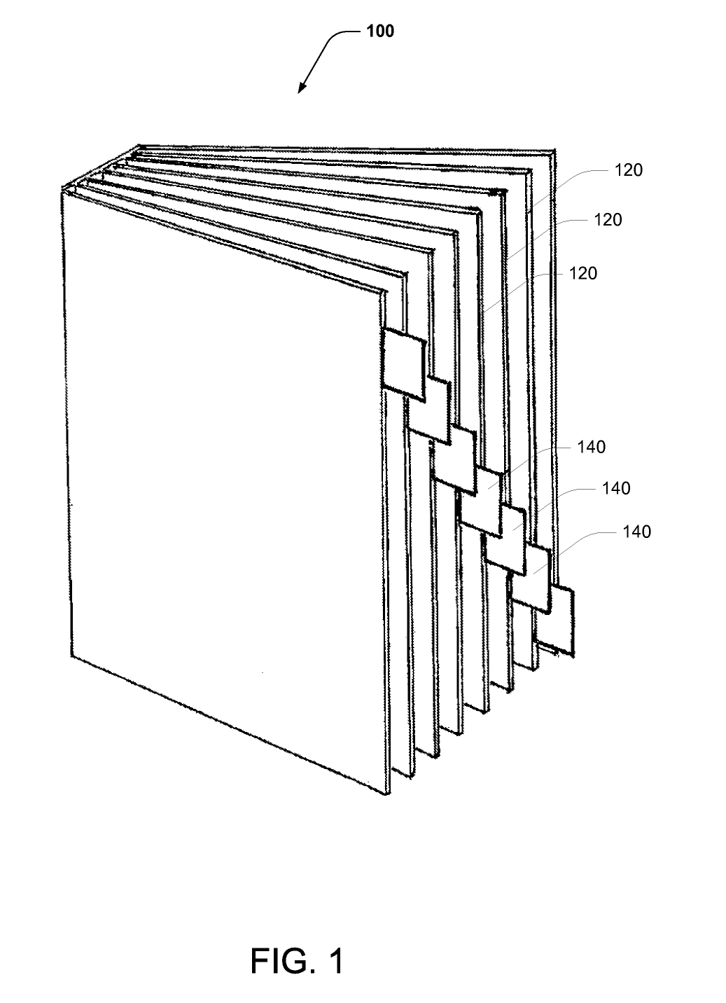

Referring to FIG. 1, an educational tool is shown in the form of a book 100 which includes a number of pages 120. The pages of the book are formed from a three-ply sandwich of thick cardboard material with an outer waterproof printed surface provided on both sides. The pages are approximately 1.5 mm to 1.7 mm thick. This ensures that when used by a young child the pages are not easily folded, and can be wiped clean.

A tab in the form of a projection 140 is associated with each page. The projections 140 are formed from silicon and are inserted into the edge of each page. The centre layer of the three-ply cardboard has a notch cut into it to receive the projection 140. Each of the projections 140 can be grasped and used to open the book 100 at the respective page that each projection 140 is associated with.

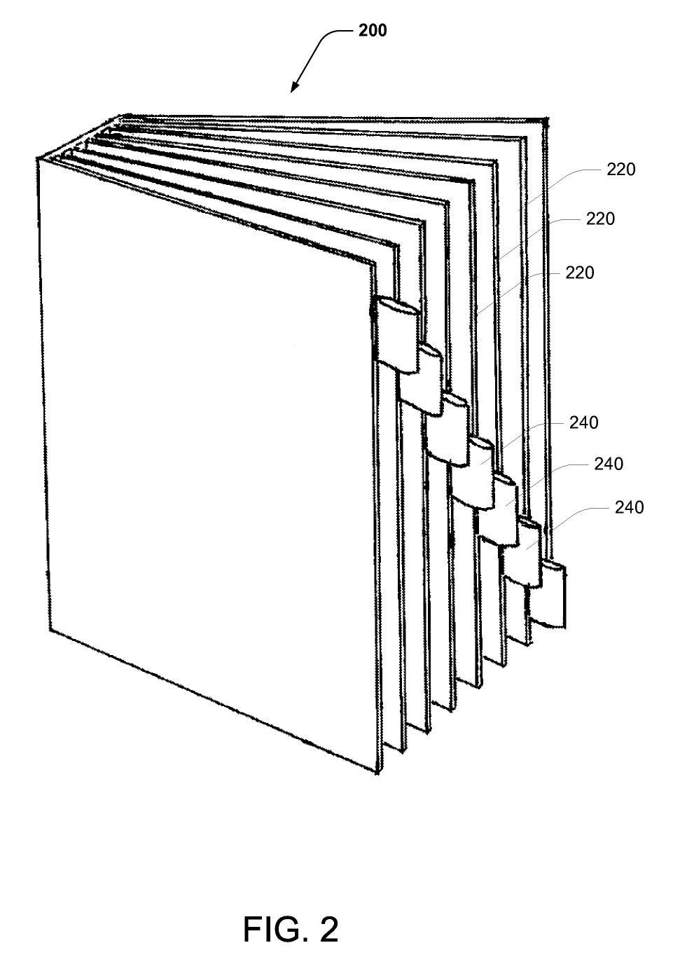

An alternative form of book 200 is shown at FIG. 2, in this embodiment pages 220 are provided with tabs in the form of loops of ribbon 240. It will be appreciated that a book can include a combination of tabs selected from either a projection 140 or loops of ribbon 240.

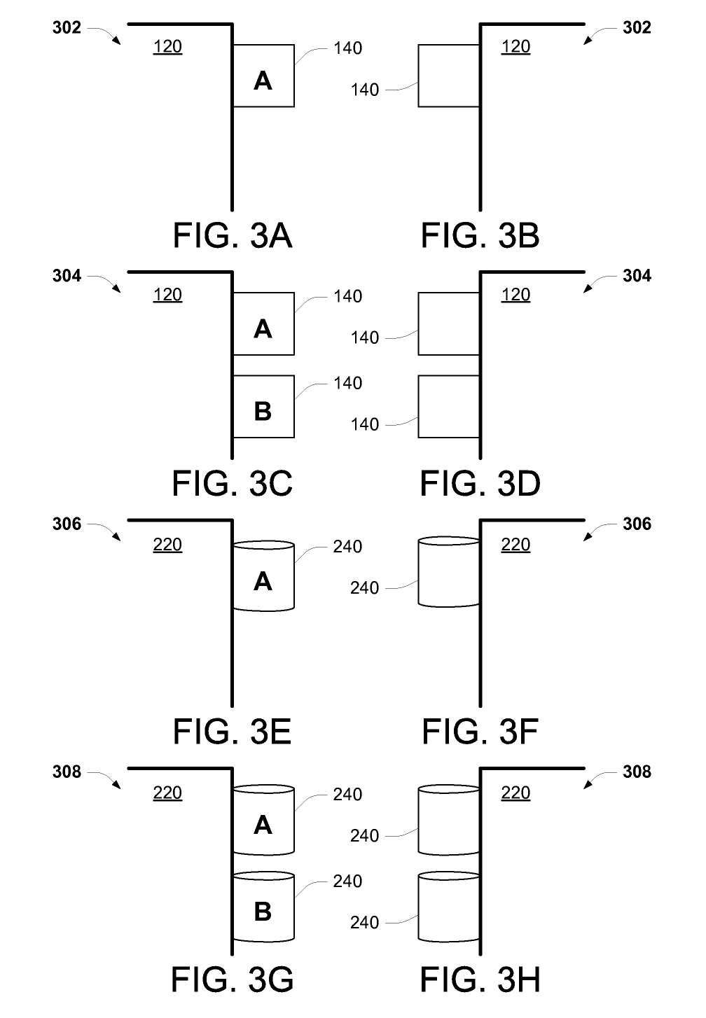

Referring to FIG. 3A, an example of a projection 140 is shown which bears an element of tab information being the letter of the alphabet “A”. The projection is printed on one side only and is blank on its rear side, as shown in FIG. 3B. At FIG. 3C, two pages are shown together, the front page 120 is associated with projection 140 “A”, and the rear page (not visible) is associated with another projection 140 “B”. These two pages are shown from the rear in FIG. 3D.

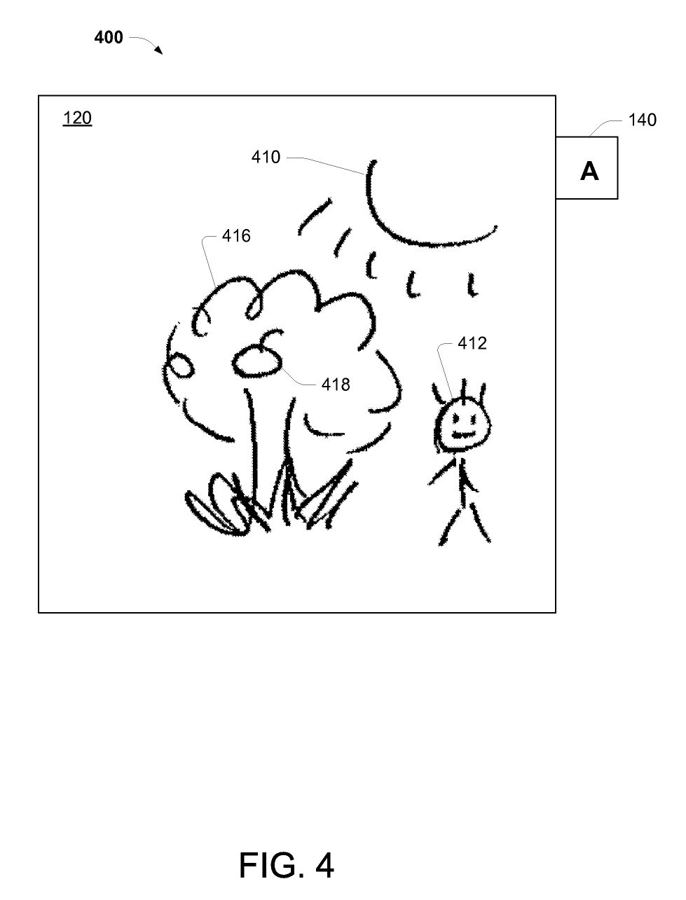

Alternative embodiments, corresponding to books shown in FIG. 3A to FIG. 3D, are shown at FIG. 3E to FIG. 3H, wherein the tabs are provided in the form of ribbon loops. Referring to FIG. 4, an example of a page 120 is shown with a projection 140, as previously shown in FIG. 3A. The page 120 includes elements of page information in the form of images being a picture of a sun 410, a person 412, a tree 416 and an apple 418. The tab information defines a criterion for a user of the book being a task that they are required to perform. In this example embodiment, the user of the book 100 is required find an item on the page which corresponds to the criterion defined by the tab information, being the letter “A”. In this example, the task is to identify the apple 418, because the word “apple” begins with the letter “A”. In other embodiments, page 120 may include words or shapes, and the task is to identify words beginning with the letter “A” or to identify shapes beginning with the letter “A”.

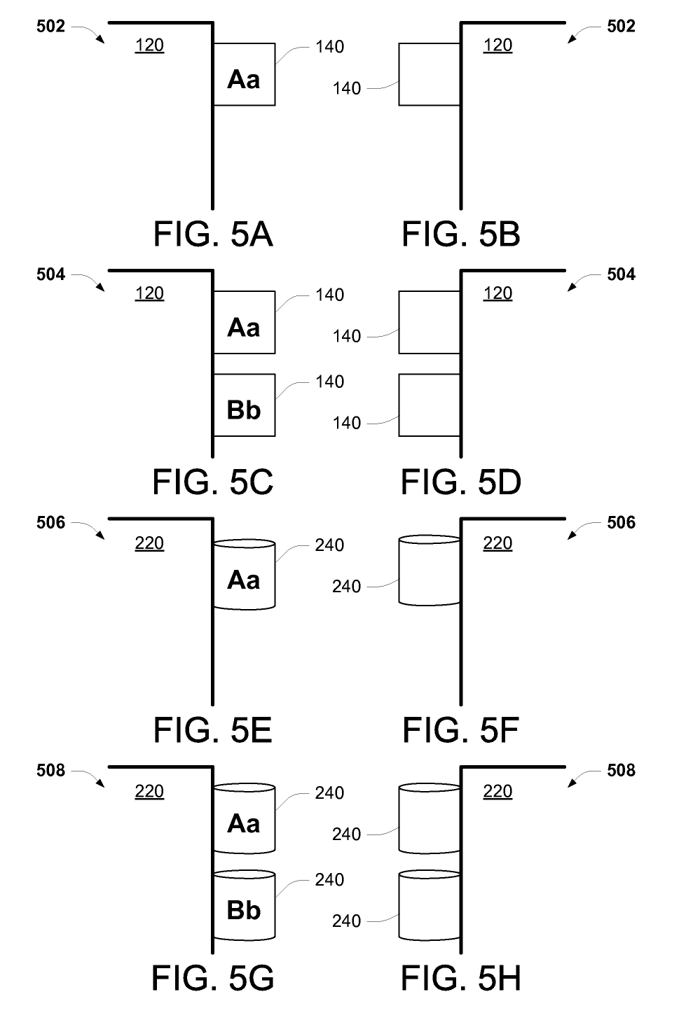

FIG. 5 through FIG. 21 show example embodiments of pages 120 and 220 having projections 140 and ribbon loops 240 respectively. In each of FIG. 5 through FIG. 21, the views (A) to (H) correspond with the views shown in FIG. 3.

In FIG. 5, the projections 120 and ribbon loops 140 include tab information being both the upper and lower case forms of the letter “A”. This arrangement can assist a student in becoming familiar with both upper and lower case letter forms.

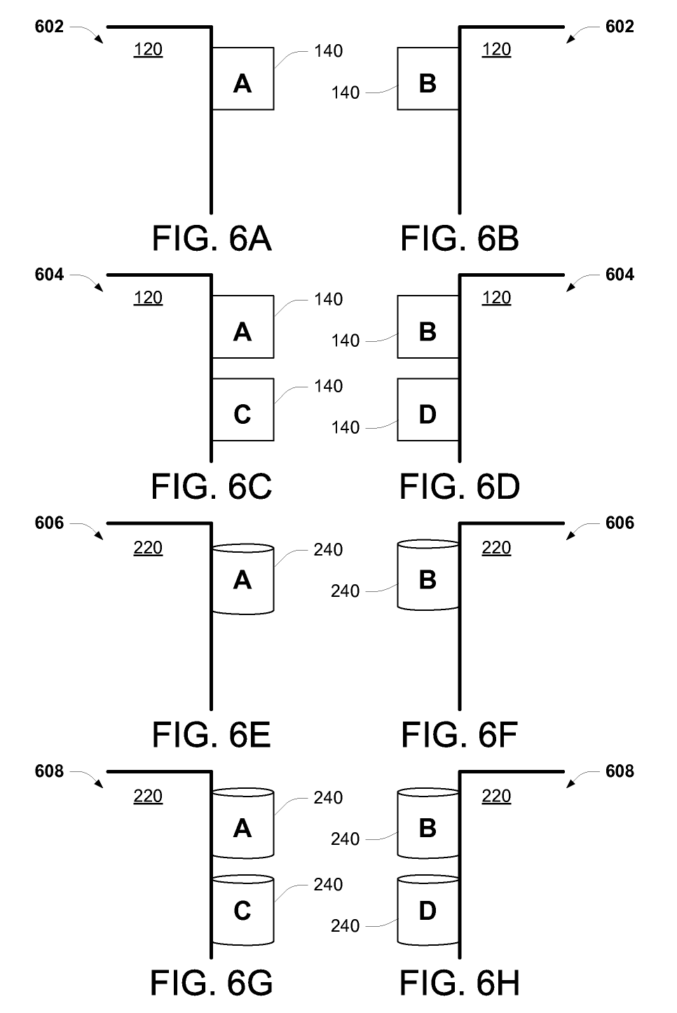

In FIG. 6, the projections 120 and ribbon loops 140 are printed on the front and the rear. The pages are similarly printed on both sides. One side of each tab relates to one side of each page.

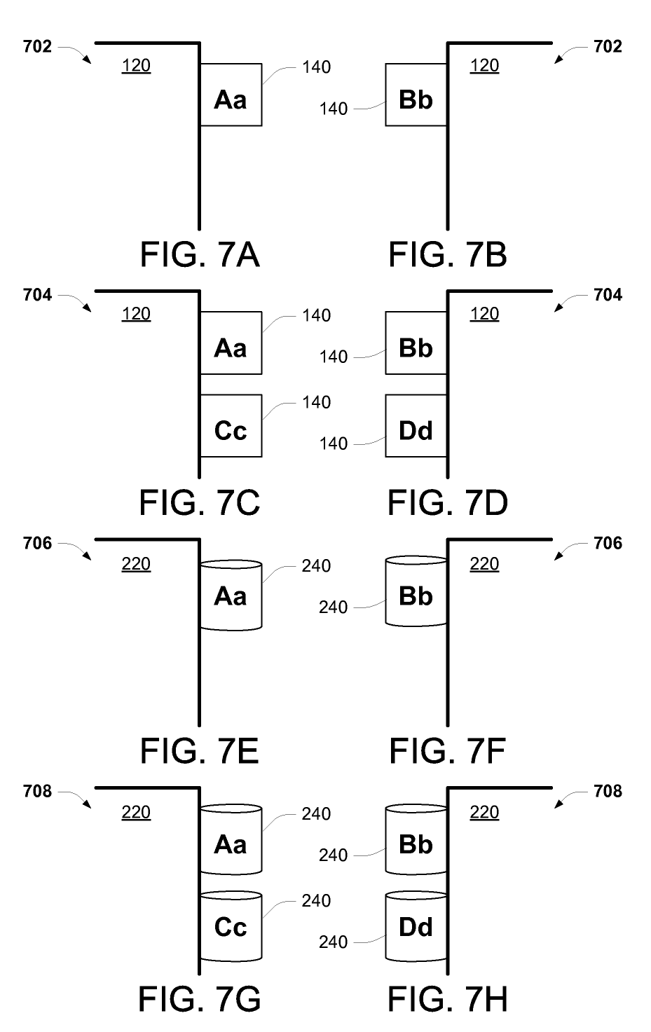

In FIG. 7, the projections 120 and ribbon loops 140 essentially comprise a combination of the arrangements of FIG. 5 and FIG. 6. By way of example, the projections 120 and ribbon loops 140 include tab information being upper and lower case letters and are printed on both sides.

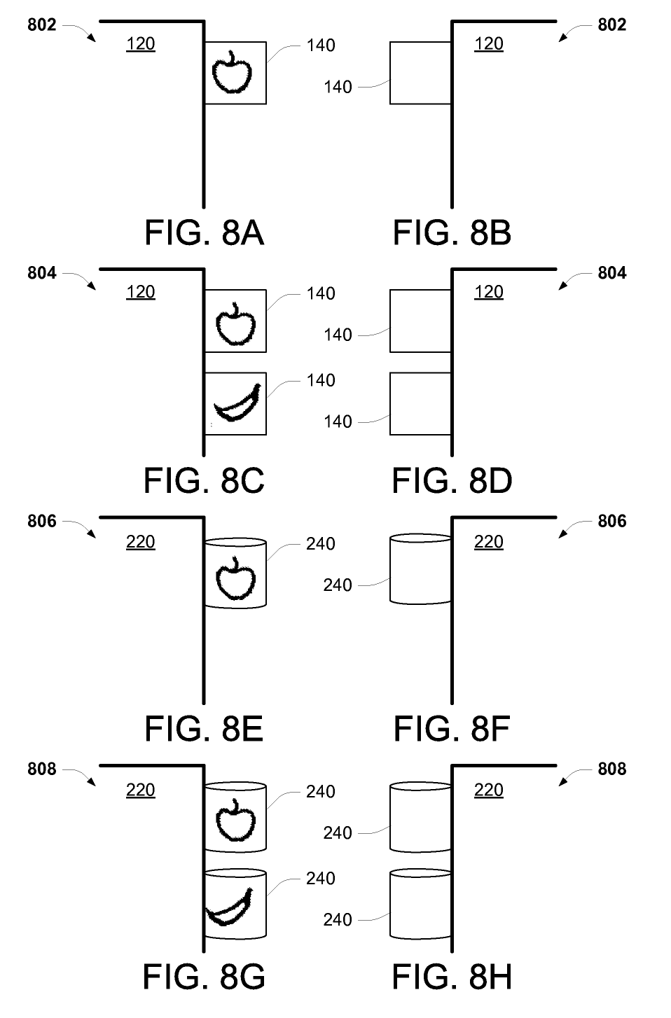

In FIG. 8, tab information is presented in the form of an image. In this example, tab information comprises images indicative of items of fruit, being an apple and a banana. A student can be required to find either corresponding images, or the words “apple”, “banana” on the page.

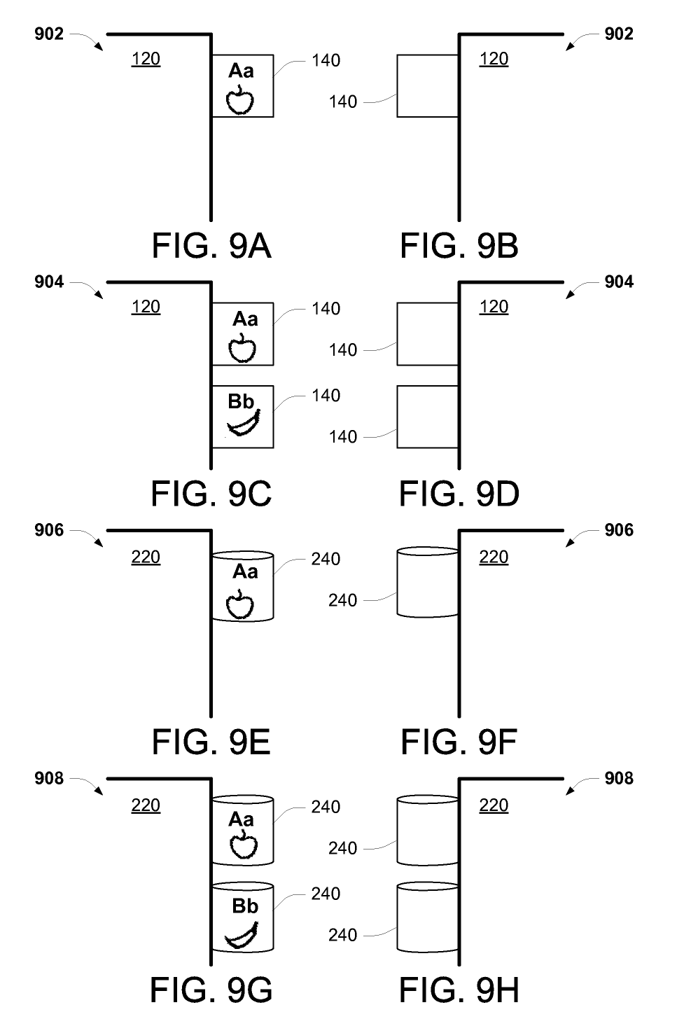

In FIG. 9, tab information is presented as a combination of the arrangements associated with FIG. 5 and FIG. 8. In this example, tab information is presented as a combination if upper and lower case letters with an image.

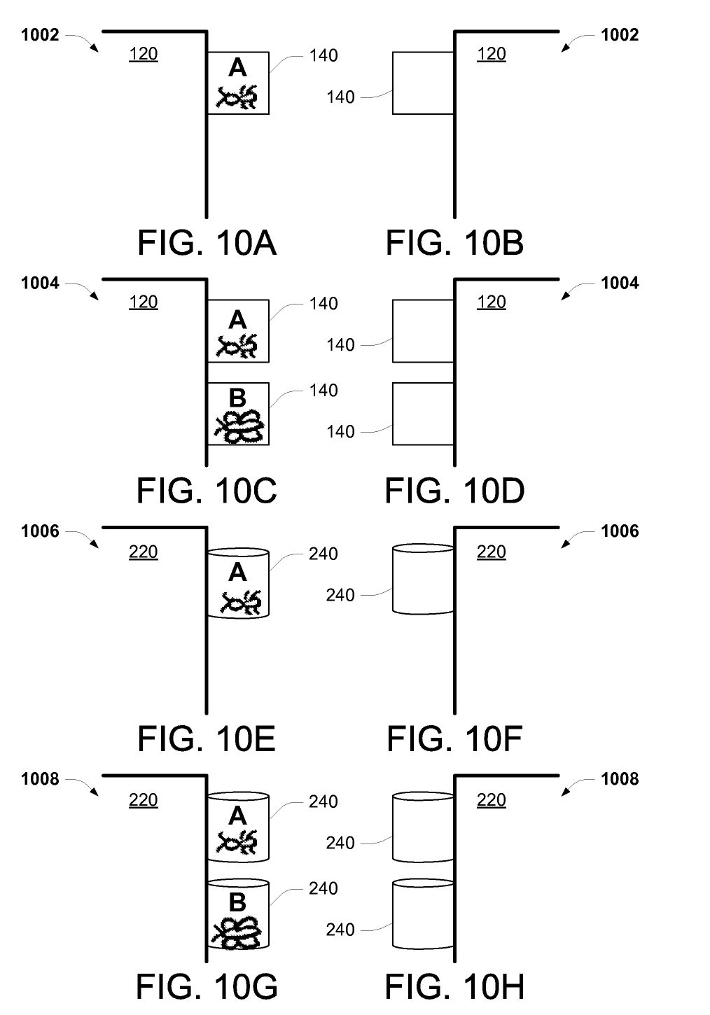

In FIG. 10, tab information includes letters and images. In this example, the images relate to insects, including an “Ant” and a “Butterfly”.

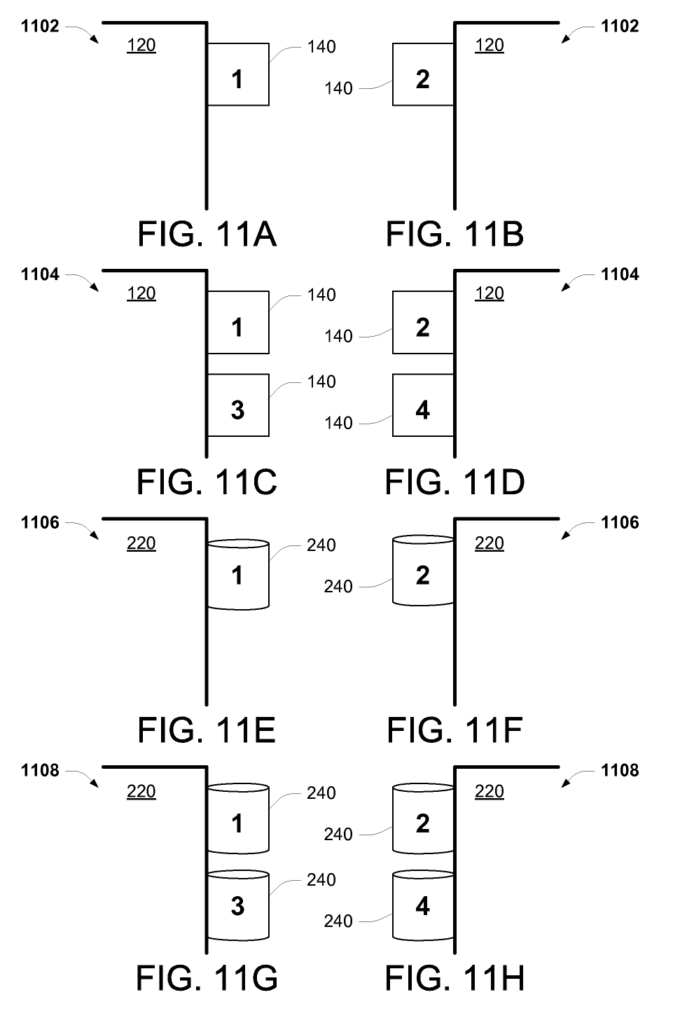

In FIG. 11, tab information includes numbers, “1”, “2”, “3” and “4”. On each corresponding page, the student is required to find that number of items.

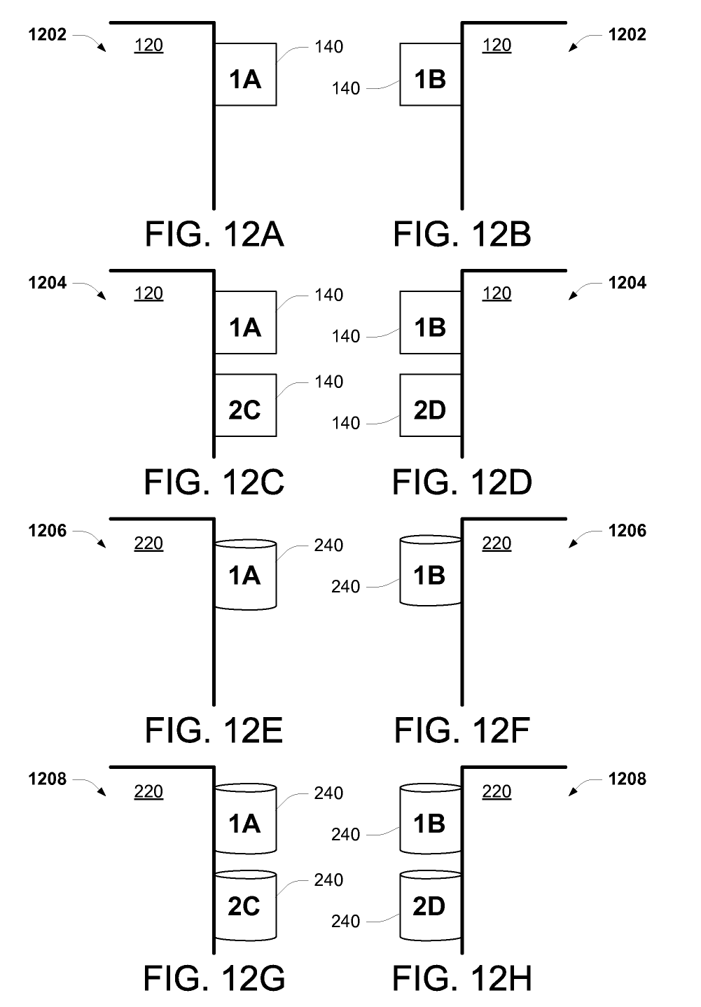

In FIG. 12, tab information includes a combination of the arrangements of FIG. 3 and FIG. 11. In this example tab information includes letters and numbers. By way of example only, a criteria defined involves finding the specified number of items beginning with the specified letter, such as “1 item beginning with A”, “2 items beginning C” etc.

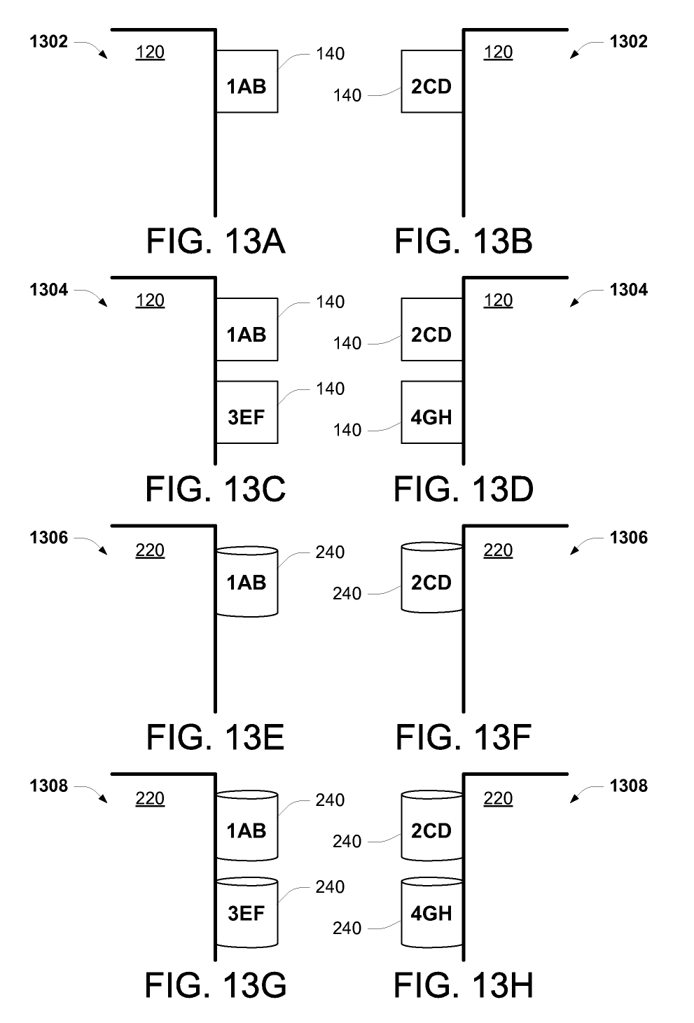

In FIG. 13, tab information includes a variation on FIG. 12, whereby two letters appear on each tab. By way of example only, the criteria are combined and a student can be required to find the specified items, such as “1 item beginning with A and 1 item beginning with B”, etc.

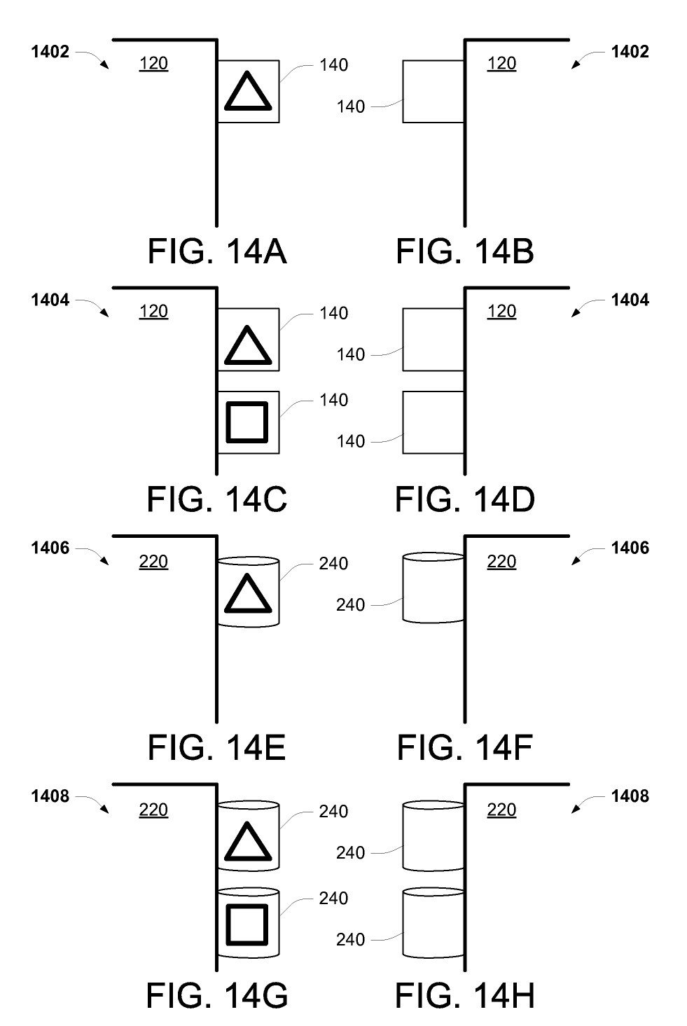

In FIG. 14, tab information includes shapes. By way of example only, a student can be required to find corresponding shapes on the page, or the words being the names of shapes “square”, “triangle” etc.

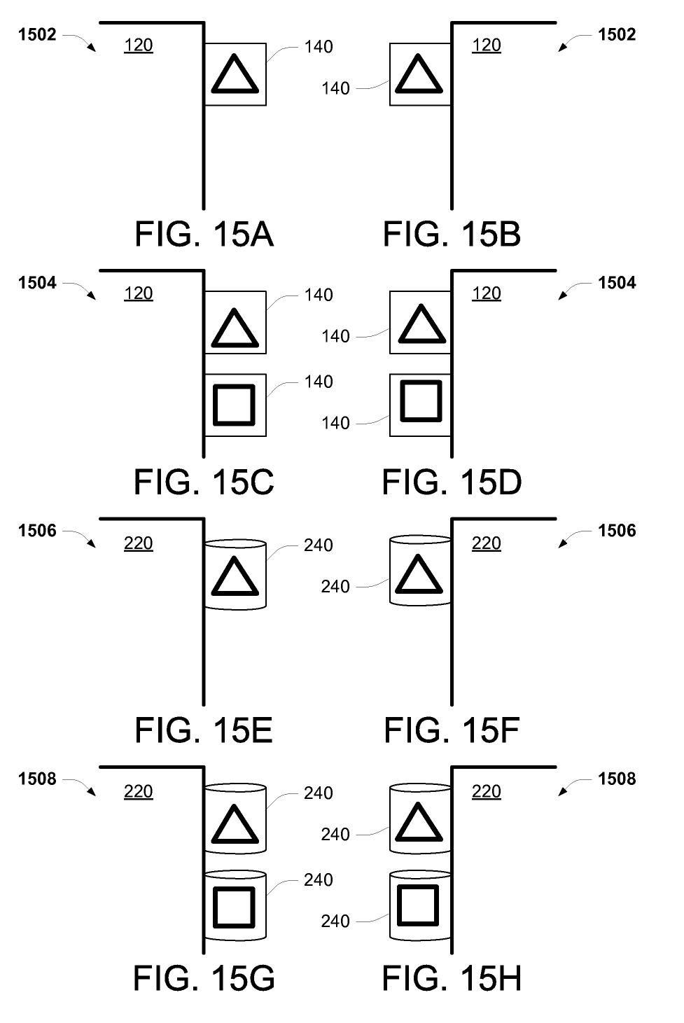

In FIG. 15, tab information of FIG. 14 can be printed on both sides.

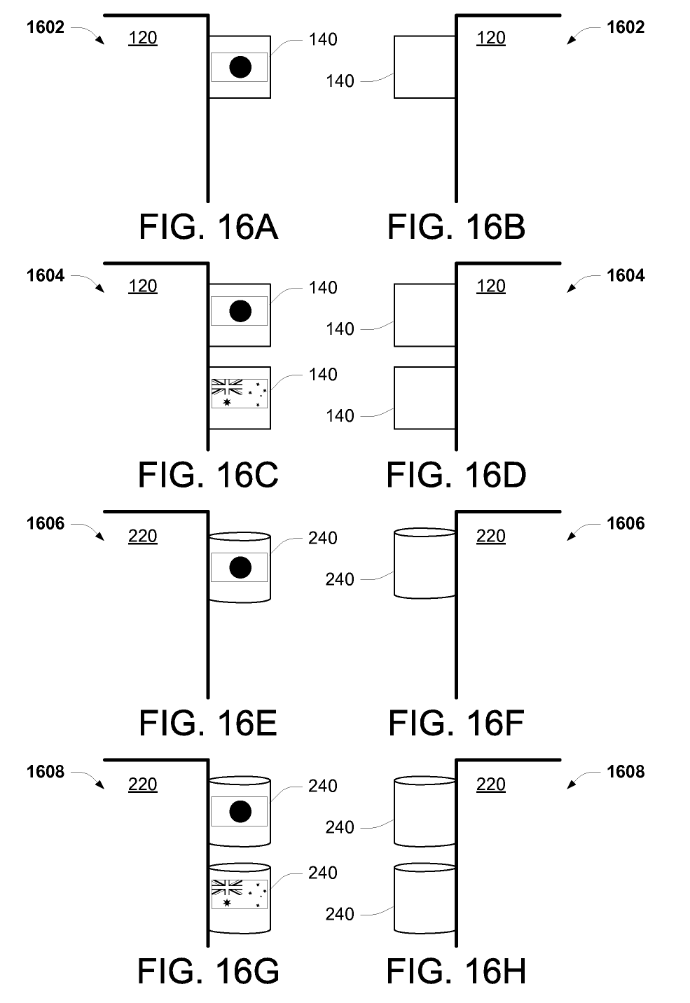

In FIG. 16, tab information includes images of national flags, including national flags of Japan and Australia. On each page, the student can be required to find corresponding images of flags, or the words being the names of the countries, “Japan”, “Australia”, etc. A student can also be required to locate the countries on a map on the page. Particular flags or countries appearing on the tab may be changed to suit the readers in different geographic locations.

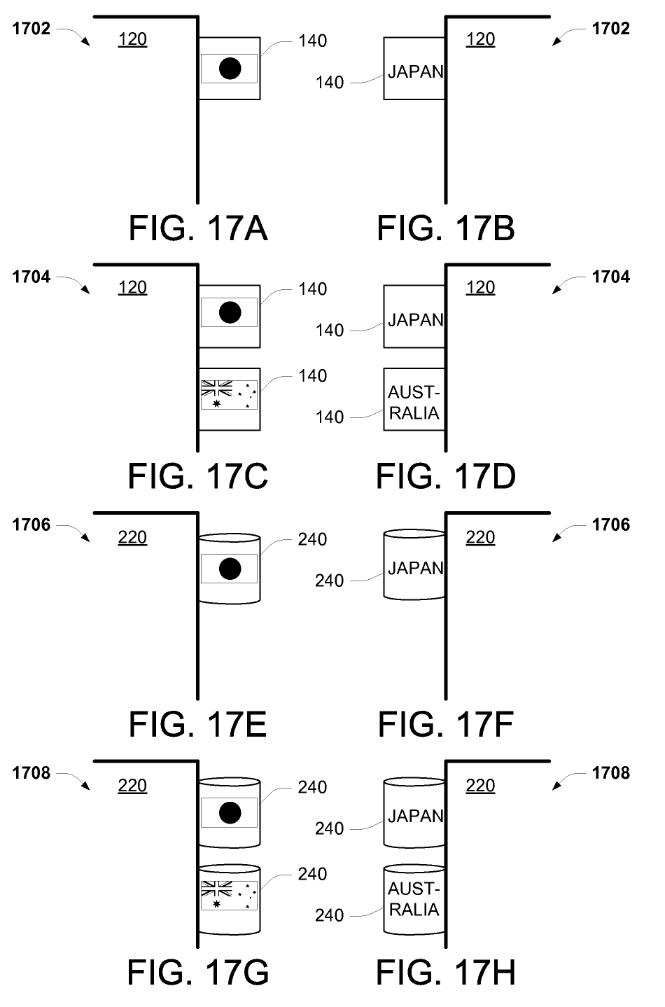

In FIG. 17, tab information can comprise a variation of FIG. 16, wherein tabs have first and second faces, being printed on both sides. By way of example only, the first face includes alpha-numeric tab information being the names the countries, the second face includes images corresponding to the alpha-numeric tab information being images of the flags of those countries.

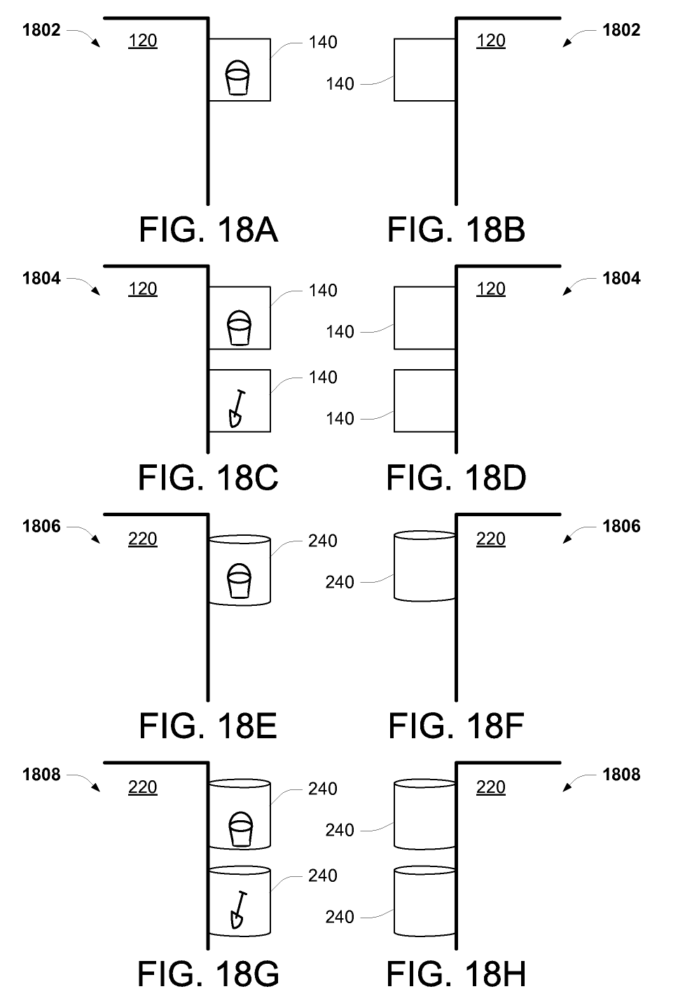

In FIG. 18, tab information includes images of objects, including “Bucket, and “Spade”. The student can be required to find corresponding words or images on the page.

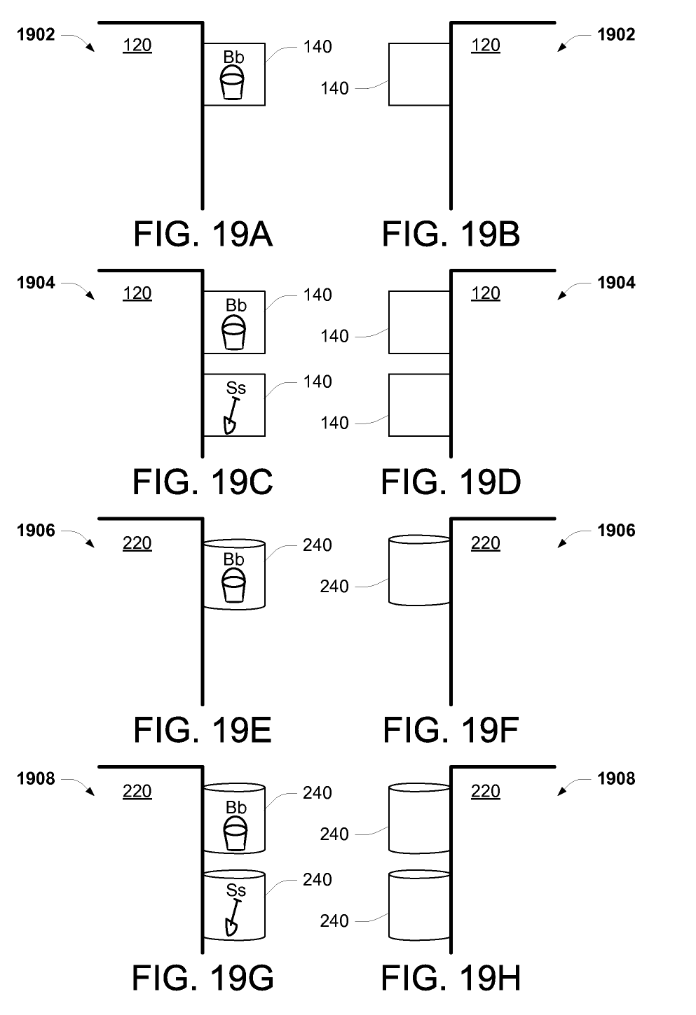

In FIG. 19, tab information includes a variation on FIG. 18, wherein the tab information further includes the first letter of the names of the items shown in the images, in this example bring “B” and “S”.

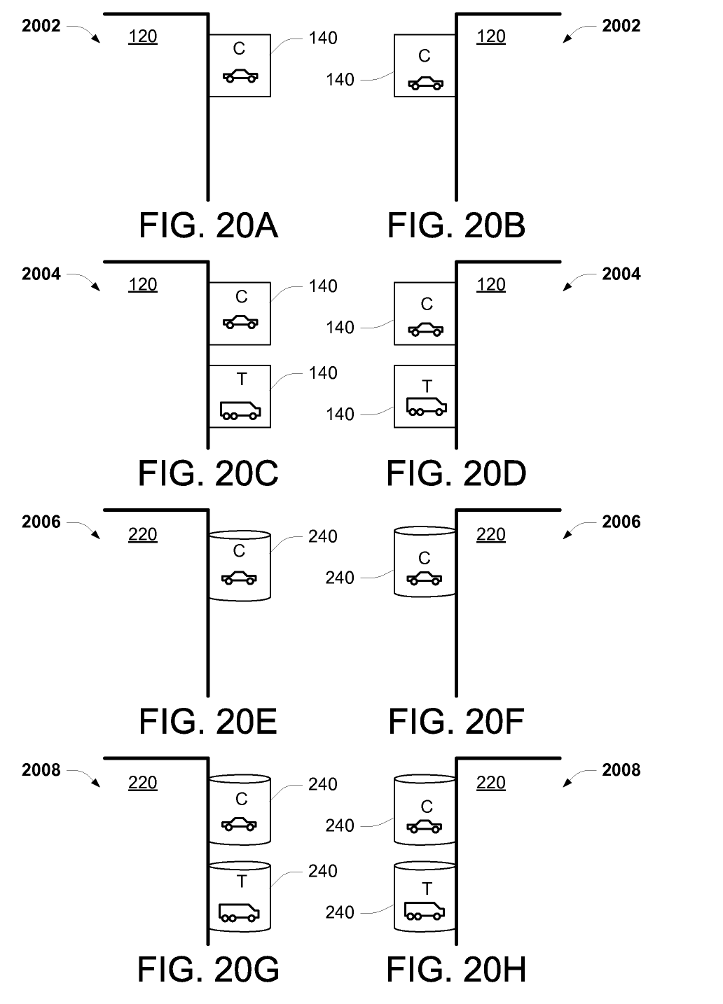

In FIG. 20, tab information includes a variation on FIG. 19, wherein the objects are a “Car” and a “Truck”.

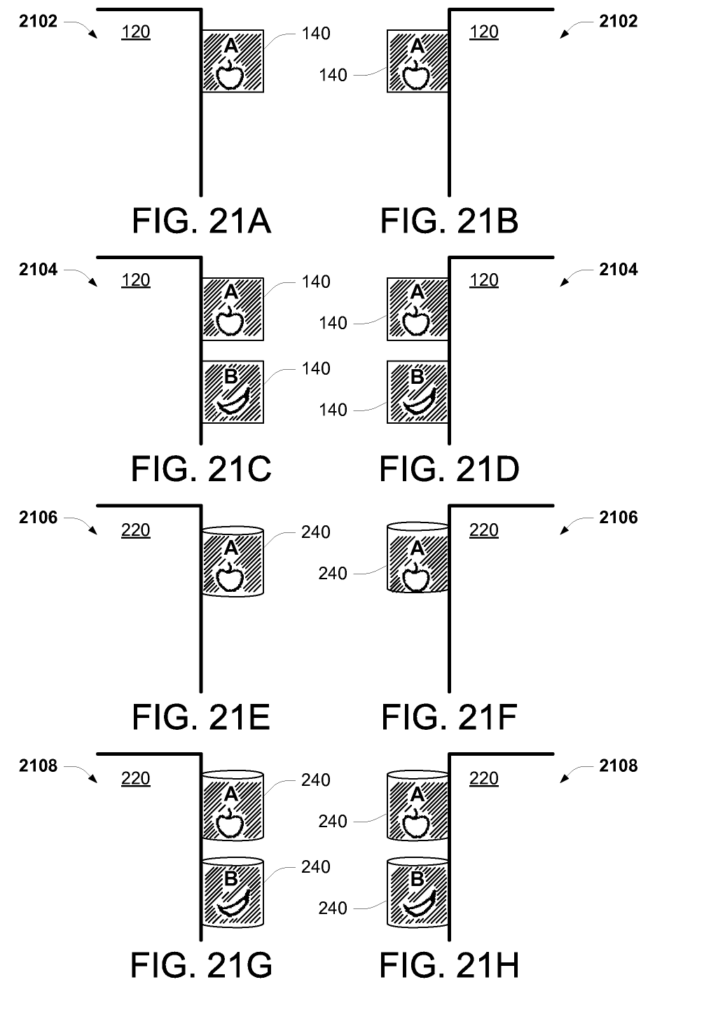

In FIG. 21, tab information is similar to that presented in FIG. 9. In this embodiment, the shape of the item is cut out from the projection. The letter can be printed.

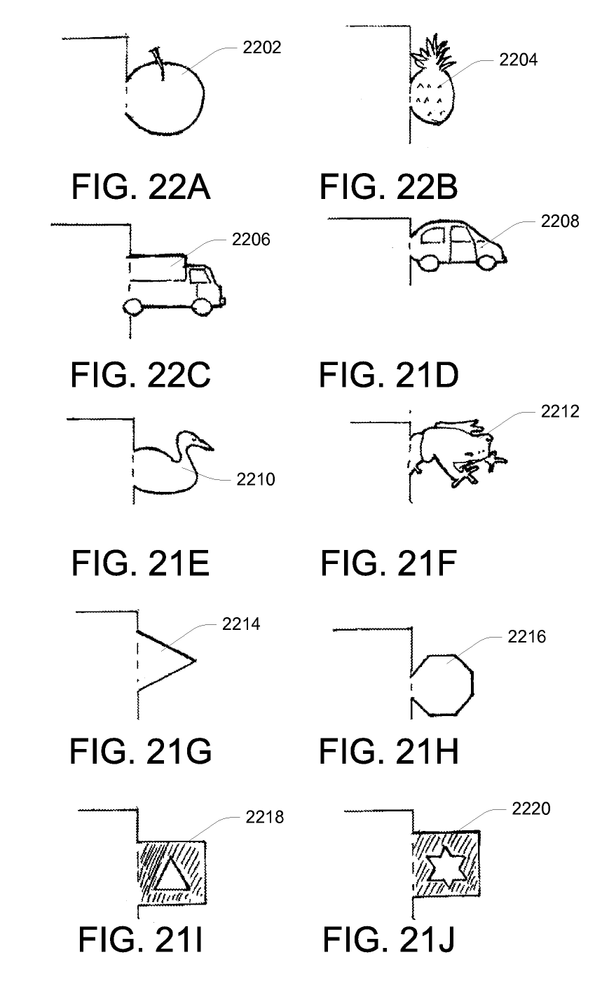

FIG. 22 further shows various example embodiments of tabs (being a projection 140 or a ribbon loop 240) which are cut out in particular shapes—or have cut out portions—including apple 2202, pineapple 2204, truck 2206, car 2208, duck 2210, frog 2212, triangle 2214, octagon 2216, triangle 2218 and star 2220.

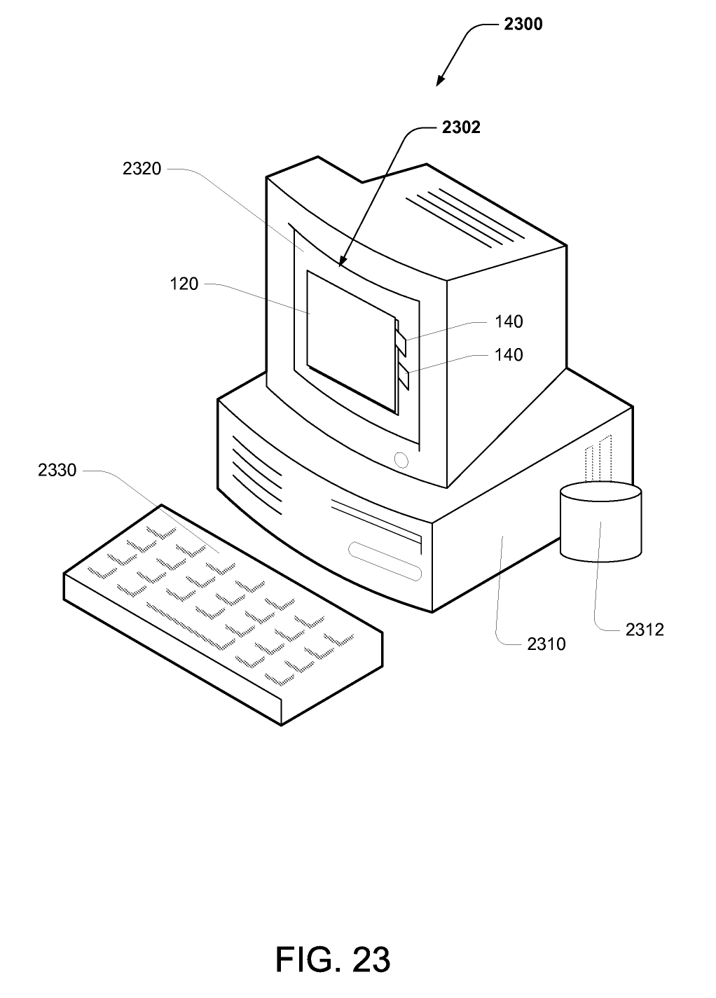

FIG. 23 shows an embodiment processor device 2300 for presenting an educational tool 2302. A user access interface 2302 is provided for a processor device to present an educational tool. The processor device 2310 is coupled to database 2312 having page data indicative of one or more pages and tab data indicative of one or more respective tabs. The interface 2302 comprises a control program adapted to present a page 120 with an associated tab 140 to a video monitor 2320. The control program being further adapted to receive user input, via a keyboard 2330. The user input being indicative of identifying at least one corresponding element of page information borne on the page with which each tab is associated.

A method of educating can comprise the steps of:
(a) providing a user access interface coupleable to database having page data indicative of one or more pages and tab data indicative of one or more respective tabs;
(b) retrieving page data and presenting at least one page;
(c) retrieving tab data and presenting one or more tabs associated with each page; and
(d) receiving user input indicative of identifying at least one corresponding element of page information borne on the page with which each tab is associated.

A computer program product can be stored on a computer usable medium, the computer program product adapted to provide this method. A computer readable medium can be used for operating with a processor device, the computer readable medium comprising computer code for executing the method.

It will be appreciated that, By attempting to identify elements of page information that correspond with the tab information, a student can becomes familiar with letters, numbers, names of objects, names of shapes, country names and flags. Thus their proficiency in the language of the book, can be improved.

In other embodiments, the book may be produced in other languages and include other alphabets or number forms accordingly.

In other embodiments the tab information may include colour coded information by way of colour coded tabs. The reader is required to identify an element on the page of a corresponding colour. In some embodiments, the tabs on consecutive pages may define a sequence of colours, such as the colours of the rainbow.

It can be seen that embodiments of the invention have at least the following advantages:
a student can be made familiar with the spellings of words;
a student can be made familiar with the names of shapes, objects and colours;
a student can be made familiar with country names and national flags;
for books intended for young children, the book can be of a sturdy and wipe-clean construction which prolongs the life of the book; and
tabs can make it easier to turn the pages, particularly for young children.

It will be appreciated that the illustrated device provides an educational tool used in teaching literacy or numeracy. By way of example, the educational tool can be used in teaching literacy or numeracy, teaching foreign languages, teaching young children and/or adult learning.

Although the invention has been described with reference to specific examples, it will be appreciated by those skilled in the art that the invention may be embodied in many other forms.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

As used herein, unless otherwise specified the use of terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader, or with reference to the orientation of the structure during nominal use, as appropriate. Similarly, the terms “inwardly” and “outwardly” generally refer to the orientation of a surface relative to its axis of elongation, or axis of rotation, as appropriate.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed herein.

1. An educational tool including:
a number of pages, at least some of which bear elements of page information;
a number of tabs are associated with the pages, at least some of which bear elements of tab information;
wherein the elements of tab information on each tab define criteria for identifying at least one corresponding element of page information borne on the page with which each tab is associated.

2. An educational tool according to claim 1, wherein the elements of tab information include any one or more elements selected from the set comprising: letters, numbers, images, shapes or colours.

3. An educational tool according to claim 2, wherein at least one of the tabs bears at least two elements of tab information and the elements of tab information combine to define criteria for identifying the corresponding elements of page information.

4. An educational tool according to claim 2, wherein at least one of the tabs has first and second faces and bears tab information on both faces, one of the faces bears alpha-numeric tab information and the other face bears tab information in another form, having a meaning corresponding to the tab information borne on the first face.

5. An educational tool according to claim 2, wherein the tab information includes a shape, being the shape of the outline of the tab.

6. An educational tool according to claim 2, wherein the tab information includes a shape, being the shape of a cut out portion of the tab.

7. An educational tool according to claim 2, a tab is associated with every one of the pages.

8. An educational tool according to claim 2, wherein the tabs are formed from either silicon or loops of ribbon.

9. The educational tool according to claim 2, wherein the elements of page information include any one or more elements selected from the set comprising: words, images, shapes or colours.

10. An educational tool according to claim 9, a tab is associated with every one of the pages.

11. An educational tool according to claim 10, wherein at least one of the tabs bears at least two elements of tab information and the elements of tab information combine to define criteria for identifying the corresponding elements of page information.

12. An educational tool according to claim 9, wherein the tabs are formed from silicon or loops of ribbon.

13. An educational tool according to claim 9, wherein the pages are formed from thick material.

14. An educational tool according to claim 9, wherein the pages have wipe clean surfaces.

15. An educational tool according to claim 1, wherein the number of pages and corresponding number of tabs are generated by a processor device and displayed by a video monitor.

16. An educational tool according to claim 15, wherein the processor device is adapted to retrieving, from a database, page data indicative of one or more pages and tab data indicative of one or more respective tabs.

17. An educational tool according to claim 15, wherein the processor device is adapted provide a user access interface to present the pages and tabs; the processor device being further adapted to receive user input indicative of identifying at least one corresponding element of page information borne on the page with which each tab is associated.
